(19) United States
(12) Patent Application Publication
(10) Pub. No.: US 2024/0337292 A1
(43) Pub. Date: Oct. 10, 2024

(54) DOUBLE OFFSET PLUNGING CONSTANT VELOCITY JOINT WITH ODD NUMBER OF BALLS

(71) Applicant: Neapco Intellectual Property Holdings, LLC, Livonia, MI (US)

(72) Inventor: Jacob G. Greenburg, Lincoln, NE (US)

(21) Appl. No.: 18/296,464

(22) Filed: Apr. 6, 2023

(51) Int. Cl. F16D 3/223

(52) U.S. Cl. CPC F16D 3/223; F16D 2003/22303

(57) ABSTRACT

A constant velocity joint includes an outer race that extends about an axis for being connected with a first shaft. An inner race extends about the axis for being connected with a second shaft. An inner surface of the outer race defines a plurality of outer channels that extend axially. An outer surface of the inner race defines a plurality of inner channels that extend axially. Each of the inner channels are in radial alignment with one of the outer channels. A plurality of balls are each located between one of the outer channels and one of the inner channels for guiding pivoting movement of the inner race relative to the outer race while transmitting rotational movement between the outer and inner races. The plurality of balls includes an odd number of balls, and according to another aspect of the disclosure, the plurality of balls includes five balls.

### FIELD

The present disclosure generally relates to a constant velocity joint, such as that used in a vehicle driveline.

### BACKGROUND

This section of the written disclosure provides background information related to constant velocity joints and is not necessarily prior art to the inventive concepts disclosed and claimed in this application.

Constant velocity (“CV”) joints are typically used in the drivelines of vehicles, such as automobiles, to provide a transfer of rotation and power between rotating shafts at a constant rotational speed and at variable angles. Specialty vehicles, such as utility terrain vehicles (“UTVs”) and all-terrain vehicle (“ATVs”) are being introduced into the market with high ground clearance and suspension stroke requirements. These new suspension types lead to high angle requirements on CV joints and plunging ball joints. It is known to modify a cage component of the CV joint to operate the CV joint at high angles, however such high-angle arrangements are prone to poor durability performance, excessive joint wear, and noise, vibration, and harshness “NVH” issues.

Accordingly, there remains a need for improvements to CV joint assemblies.

### SUMMARY

This section provides a general summary of the inventive concepts associated with this disclosure and is not intended to be interpreted as a complete and comprehensive listing of all of its aspects, objectives, features and advantages.

According to an aspect of the disclosure, a double offset plunging constant velocity joint includes an outer race that extends about an axis and defines an inner surface. An inner race extends about the axis and defines an outer surface. The inner surface of the outer race defines a plurality of outer channels that extend axially. The outer surface of the inner race defines a plurality of inner channels that extend axially. Each of the inner channels are in radial alignment with one of the outer channels. A plurality of balls are each located between one of the outer channels and one of the inner channels for guiding pivoting movement of the inner race relative to the outer race while transmitting rotational movement and torque between the outer and inner races while permitting relative axial movement between the outer and inner races. The plurality of balls includes an odd number of balls, and according to another aspect of the disclosure, the plurality of balls includes five balls.

Using an odd number of balls, preferably five balls, instead of the traditional six or eight permits larger balls to be used in a small overall joint package. The use of an odd number of balls permits a pitch circle diameter to ball diameter ratio of greater than or equal to 2.6 and less than or equal to 2.8, which provides improved joint load distribution, and leads to increased durability for components of the constant velocity joint and an increased maximum deflection angle range between the inner and outer races. Additionally, using this ratio distributes forces in the continuous velocity joint evenly, reducing an amount of contact stress along the inner and outer races during operation. The reduction in contact stress magnitude and frequency leads to longer joint life when operating at high angles. Furthermore, using an odd number of balls allows a cage to have a large internal offset between its inner and outer spheres which contributes to minimal contact stress operation at large joint angles.

### BRIEF DESCRIPTION OF DRAWINGS

The drawings described herein are for illustrative purposes only of selected embodiments and not all possible implementations and are not intended to limit the scope of the present disclosure.

FIG. 1 is a perspective, exploded view of a constant velocity joint according to an aspect of the disclosure;

FIG. 2 is a side, cross-sectional view of the constant velocity joint;

FIG. 3 is a front, cross-sectional view of a cage of the constant velocity joint;

FIG. 4 is a cross-sectional view of first side of the cage of the constant velocity joint;

FIG. 5 is a cross-sectional view of the second side of the cage of the constant velocity joint;

FIG. 6 is a side, cross-sectional view of an inner race of the constant velocity joint;

FIG. 7 is a perspective view of the inner race of the constant velocity joint;

FIG. 8 is a front view of the inner race of the constant velocity joint;

FIG. 9 is a front view of the constant velocity joint;

FIG. 10 is a front view of the constant velocity joint, illustrating an internal force distribution during pivoting of the inner and outer races relative to one another and rotation of the constant velocity joint; and

FIG. 11 is a front view of a constant velocity joint configured with a conventional six ball arrangement, illustrating an internal force distribution during pivoting of the inner and outer races relative to one another and rotation of the constant velocity joint.

### DETAILED DESCRIPTION

Referring to the figures, wherein like numerals indicate corresponding parts throughout the several views, a constant velocity joint 10 is generally shown. The subject constant velocity joint 10 may be used on the drivelines of various vehicles such as automobiles, off-road vehicles, and recreational vehicles. According to the preferred embodiments, the constant velocity joint 10 is a double offset plunging type constant velocity joint, meaning a pivot point is defined by a midpoint of two separate points of articulation and the constant velocity joint 10 accommodates axial translation.

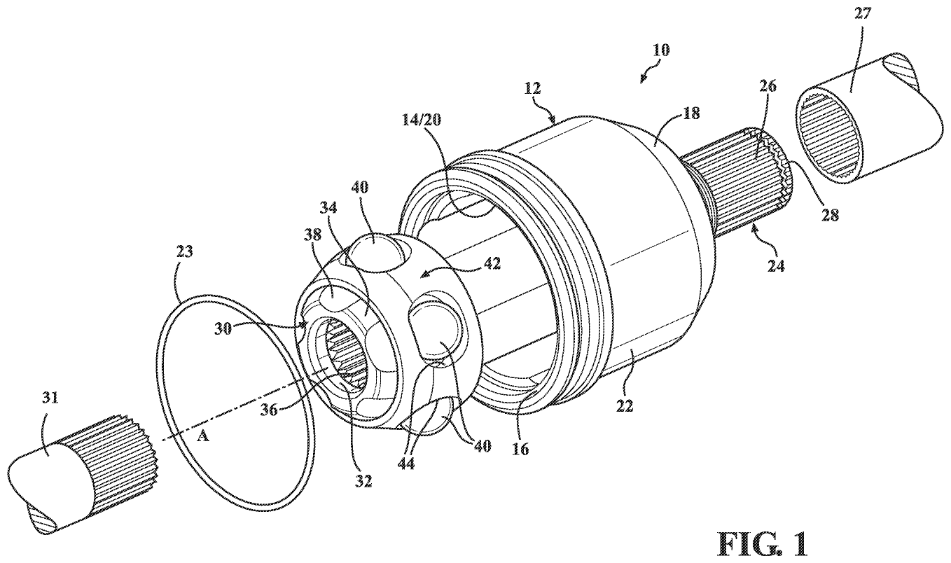

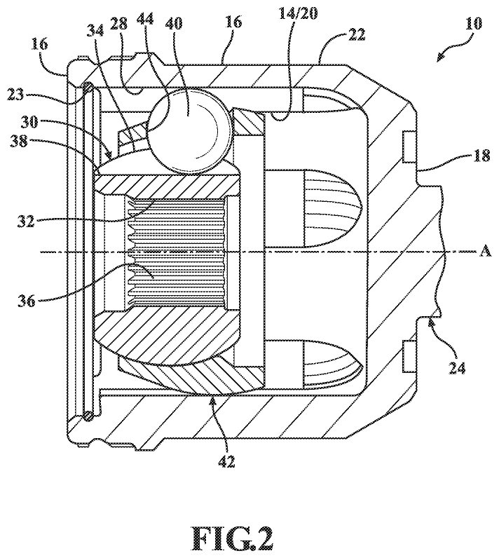

With reference to FIGS. 1 and 2, the constant velocity joint 10 includes an outer race 12 that extends about an axis A and defines a compartment 14. More particularly, the outer race 12 generally has a cup shape and extends axially between an open end 16 and a closed end 18. The outer race 12 has an inner surface 20 and an outer surface 22 opposite the inner surface 20. Together, the inner surface 20 and the closed end 18 define the compartment 14.

A first shaft 24 extends axially from the closed end 18 of the outer race 12. The first shaft 24 presents a plurality of outer splines 26 that extend axially and in circumferentially spaced relationship with one another about the first shaft 24. The outer splines 26 are configured to be interleaved with inner splines of a first connecting shaft 27 for rotationally fixing the first shaft 24 with the first connecting shaft 27. It should also be appreciated that the outer race 12 could be connected to the first connecting shaft 27 in other ways. For example, the outer race 12 could define a bore with internal splines for receiving an externally splined first connecting shaft 27 or a disk style interface could be used.

As shown in FIG. 2, the inner surface 20 of the outer race 12 defines a plurality of outer channels 28 that extend axially and are arranged in circumferentially spaced relationship with one another.

With reference to FIGS. 1, 2 and 6-8, an inner race 30 is disposed in the compartment 14 of the outer race 12 and extends about the axis A in a ring shape. The inner race 30 has an inside surface 32 and an outside surface 34. The inside surface 32 of the inner race 30 defines a plurality of inner splines 36 that extend axially and in circumferentially spaced from one another for being interleaved with external splines of a second connection shaft 31 for rotationally fixing the inner race 30 to the second connection shaft. It should also be appreciated that the inner race 30 could be connected to the second connecting shaft 31 in other ways. For example, the inner race 30 could include an externally splined shaft for being coupled with an internally splined bore of the second connecting shaft 31, or a disk style interface could be used.

The outside surface 34 of the inner race 30 defines a plurality of inner channels 38 that extend axially and are arranged in circumferentially spaced relationship with one another. The inner channels 38 are each radially aligned with one of the outer channels 28.

A plurality of balls 40 are each positioned between one of the inner channels 38 and one of the outer channels 28 for guiding pivoting movement of the inner race 30 relative to the outer race 12 while transmitting torque and rotation between the outer and inner races 12, 30, and permitting dynamic axial displacement in operation, which accommodates vehicle suspension travel.

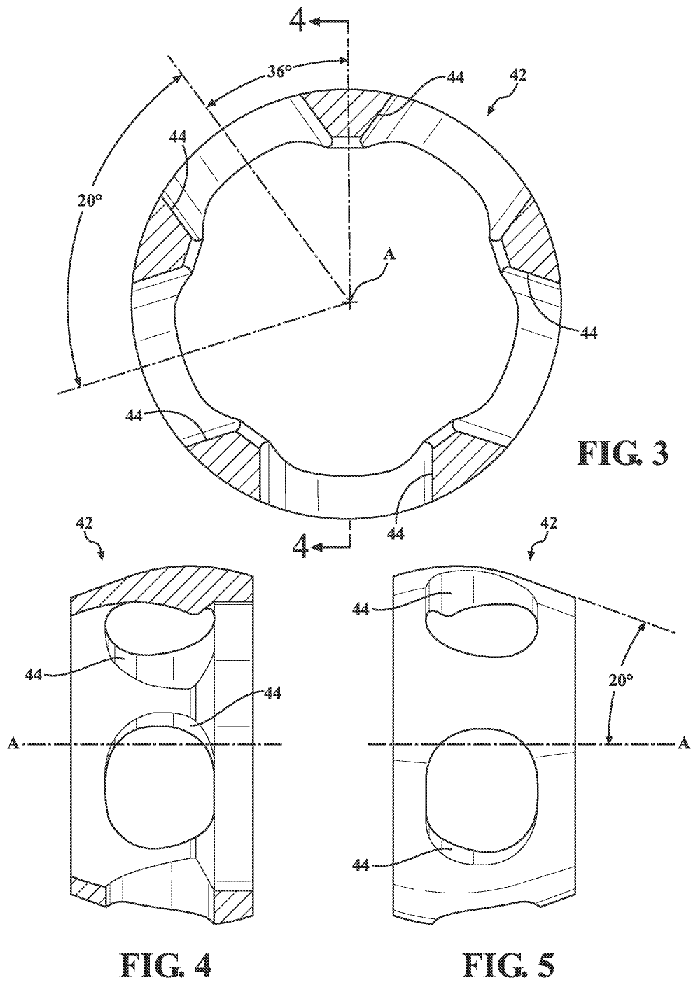

With reference to FIGS. 1-5, a cage 42 is positioned in the compartment 14 radially between the outer and inner races 12, 30. The cage 42 defines a plurality of ball openings 44, which each receive one of the balls 40 for maintaining the balls 40 in their positions in the inner and outer channels 38, 28.

A circlip 23 is located in the compartment 14 against the inner surface 20 adjacent to the open end 16 for retaining the balls 40 in the joint 10. It should be appreciated that other means could be used to retain the balls 40 in the assembly 10 such as using material staking to bulge the channels at their ends, thus making the assembly 10 permanent.

According to an aspect of the disclosure, an odd number of balls 40 and associated outer and inner channels 28, 38 are used, and the balls 40/outer and inner channels 28, 38 are equally circumferentially spaced from one another. As shown in the preferred arrangement, only five balls 40 and associated outer and inner channels 28, 38 are used.

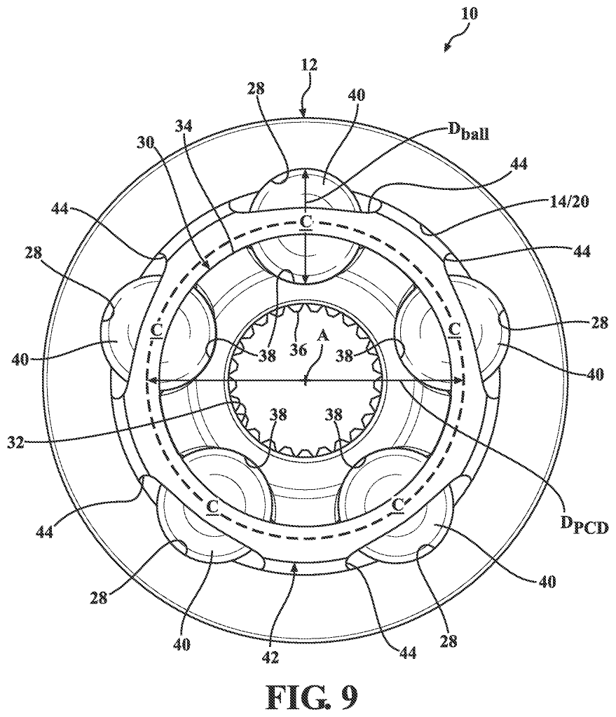

As best shown in FIG. 9, a pitch circle diameter (D_{PCD}) is defined across a circle that extends through a center C of each of the balls 40. Furthermore, each of the balls 40 has a ball diameter (D_{ball}). A pitch circle diameter D_{PCD} to ball diameter D_{ball} ratio (R=D_{PCD}/D_{ball}) is greater than or equal to 2.6 and less than or equal to 2.8 (2.6<=R<=2.8).

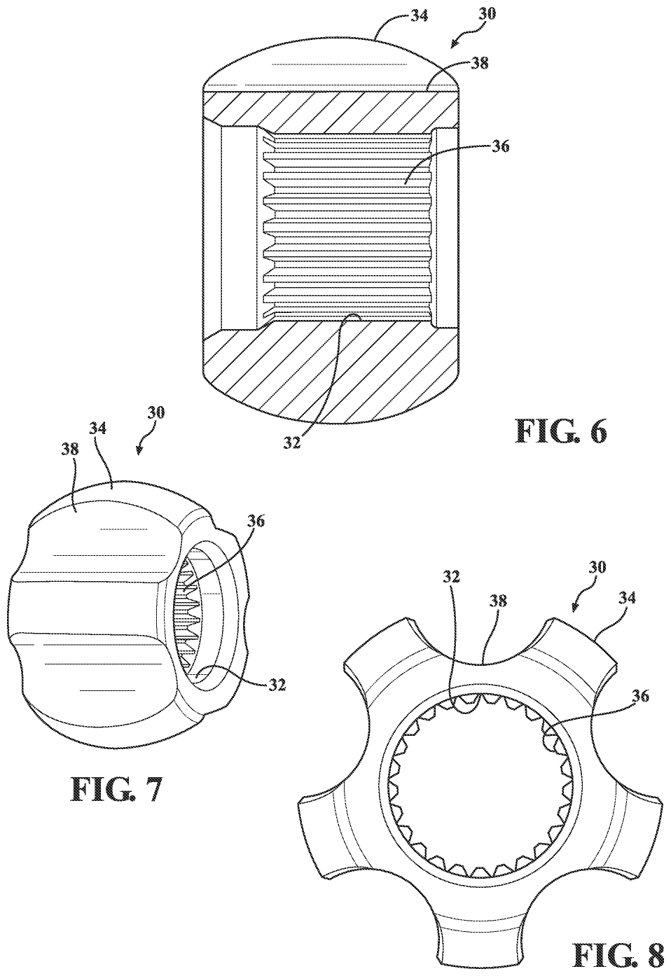

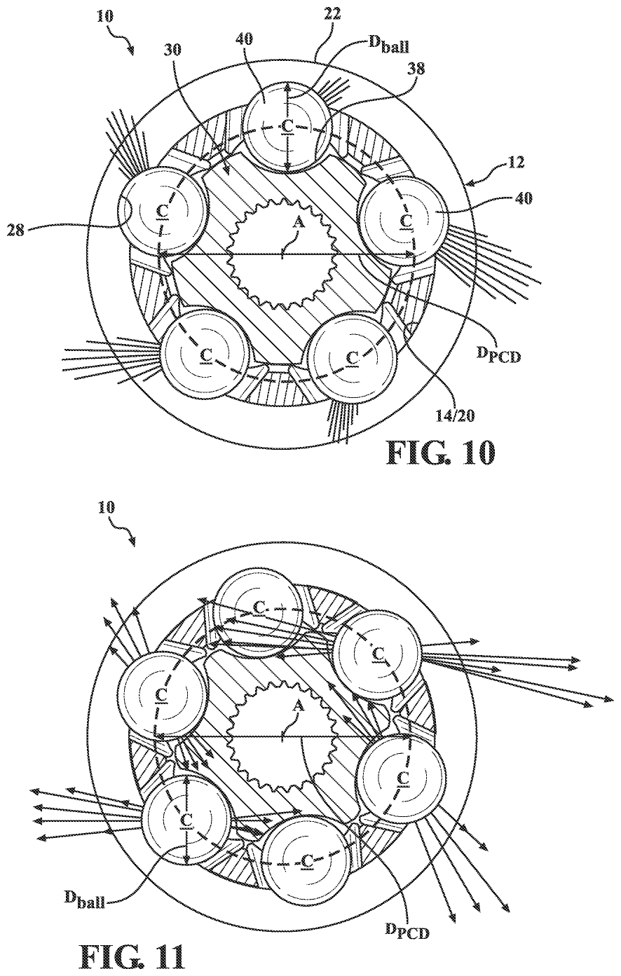

The use of only five balls 40 permits the CV joint to accommodate high operating angles, thus making the constant velocity joint 10 suitable for high-angle (e.g., 40 degrees) applications, such as off-roading. Utilizing fewer balls 40 than the six or eight conventionally used in constant velocity joints (e.g., FIG. 11) also allows for a smaller pitch circle diameter to ball diameter ratio. This allows a large ball size to be used in a small constant velocity joint package. This also allows the cage 42 to have a large internal offset between its inner and outer spheres, which improves durability and allows for the large joint angle range. Additionally, using a small, odd number of balls 40 distributes forces in the constant velocity joint 10 evenly, reducing an amount of contact stress on both the outer and the inner channels 28, 38 of the outer and inner races 12, 30 during operation. These reductions in contact stress are exemplified by FIG. 10, which shows an internal force distribution of a preferred arrangement of the constant velocity joint 10 during pivoting of the outer and inner races 12, 30 relative to one another, while FIG. 11 presents a similar plot for an example constant velocity joint which is constructed with a conventional six ball arrangement. As illustrated, the five ball arrangement of FIG. 10 provides a reduction in contact stress magnitude and frequency relative to the six ball arrangement of FIG. 6 along both the outer and inner races 12, 30, which leads to longer joint life when the constant velocity joint 10 is operated at high angles.

Obviously, many modifications and variations of the present invention are possible in light of the above teachings and may be practiced otherwise than as specifically described while within the scope of the appended claims. Individual elements or features of a particular embodiment are generally not limited to that particular embodiment, but, where applicable, are interchangeable and can be used in a selected embodiment, even if not specifically shown or described.

What is claimed is:

1. A double offset plunging constant velocity joint, comprising:
an outer race extending about an axis and defining an inner surface;
an inner race extending about the axis and defining an outer surface;
the inner surface of the outer race defining a plurality of outer channels extending axially, the outer surface of the inner race defining a plurality of inner channels extending axially, and wherein each of the inner channels are in radial alignment with one of the outer channels;
a plurality of balls each located between one of the outer channels and one of the inner channels for guiding pivoting movement of the inner race relative to the outer race while transmitting rotational movement and torque between the outer and inner races while permitting relative axial movement between the outer and inner races; and
the plurality of balls including an odd number of balls.

2. The constant velocity joint as set forth in claim 1, wherein the plurality of balls includes five balls.

3. The constant velocity joint as set forth in claim 2, wherein the plurality of outer channels includes five outer channels being in equally circumferentially spaced relationship with one another, and wherein the plurality of inner channels includes five inner channels being in equally circumferentially spaced relationship with one another.

4. The constant velocity joint as set forth in claim 1, wherein a pitch circle diameter is defined across a circle extending through a center of each of the balls, wherein each of the balls has a ball diameter, and wherein the pitch circle diameter is greater than or equal to 2.6 and less than or equal to 2.8 times the ball diameter.

5. The constant velocity joint as set forth in claim 1, further including a cage positioned between the outer and inner races and defining a plurality of ball openings each receiving one of the balls for maintaining the balls in their positions in the first and second channels.

6. The constant velocity joint as set forth in claim 1, further including a first shaft extending axially from the outer race, the first shaft for being connected with a first connecting shaft of the vehicle.

7. The constant velocity joint as set forth in claim 6, wherein the first shaft presents a plurality of outer splines extending axially and in circumferentially spaced relationship with one another for being interleaved with inner splines of the first connecting shaft for rotationally fixing the first shaft and the first connecting shaft.

8. The constant velocity joint as set forth in claim 7, wherein the outer race generally has a cup shape and extends axially between an open end and a closed end, and wherein the first shaft extends from the closed end.

9. The constant velocity joint as set forth in claim 1, wherein the inner race extends about the axis in a ring shape, and wherein the inner race has an inside surface opposite the outer surface for receiving a second connecting shaft.

10. The constant velocity joint as set forth in claim 9, wherein the inside surface of the inner race defines a plurality of inner splines that extend axially and in circumferentially spaced relationship with one another for being interleaved with external splines of a second connecting shaft for rotationally fixing the inner race to the second connecting shaft.

11. The constant velocity joint as set forth in claim 1, wherein a circlip holds the balls in place.
